(19) United States
(12) Patent Application Publication
(10) Pub. No.: US 2026/0341753 A1
(43) Pub. Date: Oct. 29, 2026

(54) HYDROGEN-GENERATING COMPOSITIONS AND STORAGE AND USE THEREOF

(71) Applicant: EMISSION FREE GENERATORS, INC., Covina, CA (US)

(72) Inventors: Mark COLLINS, Claymont, DE (US); Chase COLLINS, Claymont, DE (US)

(73) Assignee: EMISSION FREE GENERATORS, INC., Covina, CA (US)

(21) Appl. No.: 19/487,943

(22) PCT Filed: May 24, 2024
(86) PCT No.: PCT/US2024/031140

§ 371 Date: Nov. 25, 2025

Related U.S. Application Data
(60) Provisional application No. 63/504,623, filed on May 26, 2023.
(60) Provisional application No. 63/504,739, filed on May 27, 2023.

(51) Int. Cl. H01M 8/04082; C01B 3/08; H01M 8/065

(52) U.S. Cl. CPC H01M 8/04208; C01B 3/08; H01M 8/065; C01B 2203/066

(57) ABSTRACT

A hydrogen-generating composition is a powder mixture. The powder mixture includes a metal powder, an alkaline metal oxide powder, and at least one third powder that is a post-transitional metal oxide powder, a chloride salt powder of an alkali metal, a chloride salt powder of an alkaline earth metal, or combinations thereof. A fuel cartridge includes a hydrogen-generating composition contained within a fuel cartridge. The fuel cartridge has a water-permeable top section and base section made of metal or plastic or other material. A method of forming a hydrogen-generating composition includes providing powders having a predetermined particle size and mixing the powders to form the hydrogen-generating composition.

### RELATED APPLICATION

The present application claims the benefit of U.S. provisional patent application No. 63/504,623 filed May 26, 2023 and claims the benefit of U.S. provisional patent application No. 63/504,739 filed May 27, 2023, each of which is incorporated herein by reference in its entirety.

### BACKGROUND

### Field of the Invention

The present embodiments are directed to hydrogen-generating compositions, fuel packets including hydrogen-generating compositions, methods of preparing hydrogen-generating compositions, and methods of generating hydrogen gas with hydrogen-generating compositions.

### Related Art

Increasing awareness of climate change and growing energy demand has led to a significant amount of research and development into alternative energy sources, such as hydrogen.

Hydrogen gas (H2) may be used as a fuel for fuel cells to produce electric power and heat. Fuel cells convert the chemical energy from the hydrogen into electricity through a chemical reaction with oxygen. The by-product of this reaction is water.

Steam reacts with methane at high temperatures (e.g. 700 °C to 1100 °C) in the presence of a metal-based catalyst (often nickel) to generate hydrogen gas. In this process, toxic carbon monoxide (CO) is produced as by-product, and large boilers or steam reformers are required in order to produce steam to react with the methane.

Another hydrogen generation method involves the electrolysis of water, whereby an electric current is passed through water, causing water molecules to decompose into oxygen at the anode and hydrogen at the cathode.

Slow reaction time, poor efficiency, and high cost are restrictive to a convenient and immediately accessible power source with the above two examples.

Reactions between metals and water have also been extensively investigated. For example, aluminum (Al) metal reacts with water to generate hydrogen gas (H2) according to the following equation:

Al (s)+3H₂O (g)→Al(OH)₃ (s)+1.5H₂ (g) ΔHr=−280 kJ/mol

One problem, however, with the reaction between aluminum and water i1s that a protective coating of aluminum oxide is very rapidly formed on the surface of the metal, thereby inhibiting further reaction with underlying aluminum. After a short initial burst of hydrogen generation, further evolution of hydrogen ceases or proceeds only very slowly. The overall slow speed of reaction is a limiting factor for providing immediately accessible gas.

Various additives to facilitate the reaction of aluminum with water have therefore been investigated.

Wang et al. (“Preparation and Hydrolysis of Aluminium Based Composites for Hydrogen Production in Pure Water”, Materials Trans. (2014), Vol. 55, pp. 892-898) reported on the effect of additives including calcium oxide (CaO), sodium chloride (NaCl), and the low melting point metals gallium (Ga), indium (In), and tin (Sn) on the hydrolysis activity of aluminum in water. The total hydrogen yield (volume) per gram of aluminum for compositions containing a mixture of aluminum and CaO composites ranged from 10 mL to 110 mL. This is far below the maximum theoretical yield of 1358 mL for 1 g Al reacting with water completely at 25 °C and 1 atmosphere of pressure. By adding NaCl to the Al—CaO compositions, the hydrogen yield increased, but only up to a maximum of 54% of the maximum theoretical yield. However, Wang et al. found that by using aluminum alloys containing metals such as Ga, In, and Sn in combination with CaO and NaCl, yields of greater than 80% could be obtained. Even with the use of Ga, In, and Sn alloys, however, yields of greater than 80% were only observed at high temperatures (60 °C). The use of such metals and the preparation of the aluminum alloys is expensive, and hence the commercial potential of such mixtures as fuel sources is limited.

Wang et al. (“Generation of hydrogen from aluminium and water-Effect of metal oxide nanocrystals and water quality”, Int. J Hydrog. Energy (2011), Vol. 36, pp. 15136-15144) reported on the effect of the addition of various first-row transition metal oxide nanocrystals to the reaction between aluminum and water to generate hydrogen.

Dupiano et al. (“Hydrogen production by reacting water with mechanically milled composite aluminium-metal oxide powders”, Int. J Hydrog. Energy (2011), Vol. 36, pp. 4781-4791) reported on the reaction of certain mechanically-milled aluminum-metal oxide powders with water. Dupiano et al. found that for a powder containing a mixture of aluminum and cupric oxide (CuO), when conducted at room temperature, no reaction was observed for the first three days.

Chen et al. (“Research of hydrogen generation by the reaction of Al-based materials with water”, J Power Sources (2013), Vol. 222, pp. 188-195) reported on the reaction of various compositions containing Al, CaO, and NaCl prepared by mechanical ball-milling for hydrogen production.

At the present time, there remains the need for hydrogen-generating compositions that generate hydrogen gas in high yields at ambient temperatures, none of the above examples meets these needs. If they are to be used as fuels for generating hydrogen for consumption in fuel cells, hydrogen-generating compositions should be in a convenient and accessible user-friendly format, and such compositions need to be relatively inexpensive to manufacture and safe to use by untrained operatives. In particular, the compositions should generate hydrogen only when required to meets the needs for specific electrical demand, in a repeatable, controlled manner to avoid overheating and over-pressurization of the hydrogen-generating apparatus in which the compositions may be used and should be readily transportable, including via mail or courier delivery, in convenient handheld, consumer compliant, packages.

Therefore, what is needed is a system and method that overcomes these significant problems found in the conventional systems as described above.

### SUMMARY

In some aspects, the techniques described herein relate to a hydrogen-generating composition, wherein the hydrogen-generating composition is a powder mixture including a metal powder, an alkaline metal oxide powder, and at least one third powder selected from the group consisting of a post-transitional metal oxide powder, a chloride salt powder of an alkali metal, a chloride salt powder of an alkaline earth metal, and combinations thereof.

In some aspects, the techniques described herein relate to a hydrogen-generating composition, wherein the metal powder is an aluminum powder.

In some aspects, the techniques described herein relate to a hydrogen-generating composition, wherein the metal powder is at least 95% by weight of the hydrogen-generating composition.

In some aspects, the techniques described herein relate to a hydrogen-generating composition, wherein the alkaline metal oxide powder is a calcium oxide powder.

In some aspects, the techniques described herein relate to a hydrogen-generating composition, wherein the alkaline metal oxide powder is up to 7% by weight of the hydrogen-generating composition.

In some aspects, the techniques described herein relate to a hydrogen-generating composition, wherein the post-transitional metal oxide powder is at least 0.15% by weight of the hydrogen-generating composition.

In some aspects, the techniques described herein relate to a hydrogen-generating composition, wherein the chloride salt powder of the alkali metal or the chloride salt powder of the alkaline earth metal is up to 1% by weight of the hydrogen-generating composition.

In some aspects, the techniques described herein relate to a hydrogen-generating composition, wherein the at least one third powder is selected from the group consisting of sodium chloride, potassium chloride, calcium chloride, and combinations thereof.

In some aspects, the techniques described herein relate to a hydrogen-generating composition, wherein the powder mixture has a D90 particle size in the range of 30 microns to 100 microns.

In some aspects, the techniques described herein relate to a hydrogen-generating composition, wherein the powder mixture further includes a catalyst powder.

In some aspects, the techniques described herein relate to a fuel including a hydrogen-generating composition contained within a cartridge, wherein the fuel cartridge is of a grid construction with metal base, heat resistant sides and permeable top.

In some aspects, the techniques described herein relate to a fuel cartridge, wherein the fuel pouch is formed of a plastic, metal and fabric.

In some aspects, the techniques described herein relate to a fuel cartridge, wherein the fuel cartridge top is formed of a fabric material selected from the group consisting of Nylon, fiberglass thread, aluminum, glass, silica cloth, silicone/fiberglass cloth, copper mesh, brass mesh, or stainless-steel mesh.

In some aspects, the techniques described herein relate to a fuel cartridge, wherein the fuel pouch has a mesh size of about 500 to about 140.

In some aspects, the techniques described herein relate to a fuel cartridge further including a sealed sleeve containing the fuel pouch.

In some aspects, the techniques described herein relate to a fuel cartridge, wherein the sealed sleeve is vacuum sealed.

In some aspects, the techniques described herein relate to a fuel cartridge, wherein the sealed sleeve is formed of aluminum foil.

In some aspects, the techniques described herein relate to a method of forming a hydrogen-generating composition including: providing a metal powder, an alkaline metal oxide powder, and at least one third powder selected from the group consisting of a post-transitional metal oxide powder, a chloride salt powder of an alkali metal, and a chloride salt powder of an alkaline earth metal, the metal powder, the alkaline metal oxide powder, and the at least one third powder having a predetermined particle size; and mixing the metal powder, the alkaline metal oxide powder, and the at least one third powder to form the hydrogen-generating composition.

In some aspects, the techniques described herein relate to a method further including the metal powder preferably being of a recycled nature that has undergone ball milling the metal powder to achieve the desired micron size particle, the alkaline metal oxide powder, and the least one third powder to the predetermined particle size.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a block diagram illustrating an example partial cross sectional view of a fuel cartridge in fuel cartridge according to an embodiment of the present disclosure;

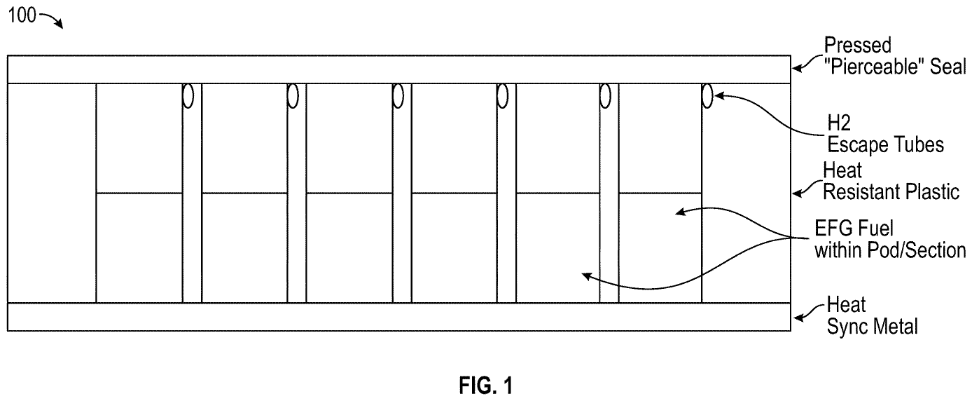

FIG. 2 is a block diagram illustrating an example partial cross top view (without pressed pierceable seal) of a fuel cartridge in fuel cartridge according to an embodiment of the present disclosure;

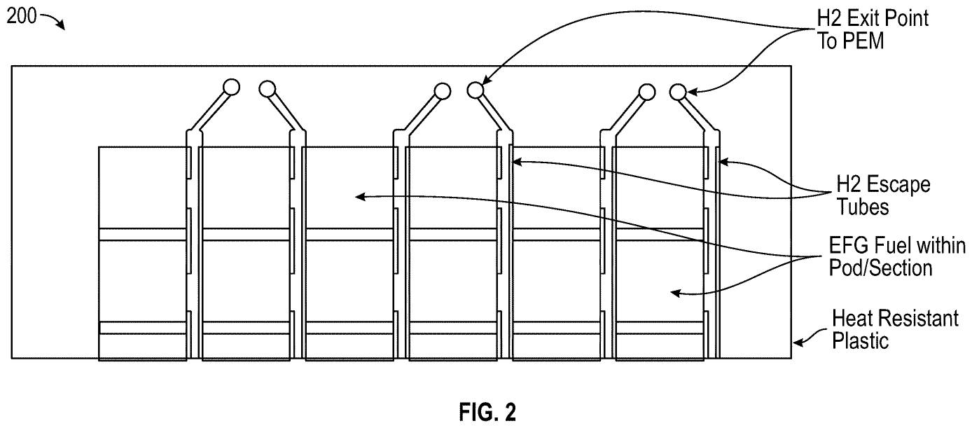

FIG. 3 is a graph diagram illustrating an example time resolved reaction of the reaction completeness of 10 g water and 10 g fuel over time;

FIG. 4 is a block diagram illustrating an example of residue after reaction completion between fuel and water;

FIG. 5 is a graph diagram illustrating an example comparison of reaction temperature as a function of time;

FIG. 6 is a graph diagram illustrating an example comparison of ground vs. non-ground NaOH initial rates;

FIG. 7 is a graph diagram illustrating an example comparison of mass lost by two reactions as a function of time;

FIG. 8 is a graph diagram illustrating an example comparison of a normalized reaction rate of 10 g vs. 20 g fuel mass scale; and

FIG. 9 is a graph diagram illustrating an example comparison of temperature generation of 10 and 20 g scale reactions.

### DETAILED DESCRIPTION

Disclosed herein are a hydrogen-generating composition, a fuel cartridge to contain the hydrogen-generating composition, and a method for making the hydrogen-generating composition. For example, in one aspect, the hydrogen-generating composition is a powder mixture for a fuel. The powder mixture includes a metal powder, an alkaline metal oxide powder, and at least one third powder that is a post-transitional metal oxide powder, a chloride salt powder of an alkali metal, a chloride salt powder of an alkaline earth metal, or combinations thereof. In one aspect, the fuel cartridge contains the hydrogen-generating composition and has a water-permeable top section and metal base section. In one aspect, the method of forming the hydrogen-generating composition includes providing powders having a predetermined particle size and mixing the powders to form the hydrogen-generating composition.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

Provided are hydrogen-generating compositions, fuel cartridges, and methods of forming and using hydrogen-generating compositions.

Embodiments of the present disclosure, for example, in comparison to concepts failing to include one or more of the features disclosed herein, provide a high-yield hydrogen-generating fuel source, provide a contained hydrogen-generating fuel source, provide high-yield hydrogen production, provide a long-term-storable hydrogen-generating fuel source, or combinations thereof.

In exemplary embodiments, the hydrogen-generating composition generates hydrogen in high yields when contacted with water. Preferably, the release of hydrogen is controllable to provide low pressures of hydrogen over a prolonged period of time.

In exemplary embodiments, the hydrogen-generating composition is useful in generating hydrogen for conversion into electricity by a hydrogen fuel cell.

In exemplary embodiments, the hydrogen-generating composition is contained in a ready-to-use, safe, convenient, practical, and price-conscious fuel cartridge.

Exemplary embodiments include the use of a hydrogen-generating powder contained within a cartridge. When placed within an appropriate apparatus (e.g., the EFG electricity generator) configured to provide a measured distribution of water to inside the cartridge, the fuel measured specifically and positioned with the aid of segmentation within the cartridge reacts with a precise quantity of water and produces hydrogen gas that may be used within the EFG hydrogen-based power-generating system.

The fuel cartridge includes a hydrogen-generating composition contained within a fuel cartridge. The fuel cartridge is sealed within a vacuum sealed sleeve for long-term storage of the hydrogen-generating composition. In exemplary embodiments, the reaction efficiency (end of chemical reaction) of the hydrogen-generating composition when contained within the cartridge is <95%.

### Composition

A hydrogen-generating composition generates hydrogen when contacted with water. In exemplary embodiments, the hydrogen-generating composition includes aluminum powder, an alkaline metal oxide powder, and either a post-transitional metal oxide powder or a chloride salt powder of an alkali metal or alkaline earth metal.

While the effects of the addition of single metal oxides and single metal chlorides to the reaction between aluminum and water have been investigated, the effects of using combinations of metal oxides or combinations of metal chlorides as additives has been unknown up until now.

The use of a combination of alkaline metals and transition metal oxides provides a total volume of hydrogen that is synergistically greater than when either one of the oxides is used alone.

In exemplary embodiments, a metal powder of a metal is combined/mixed with an alkaline metal oxide in a specific efficient ratio and is optionally also combined/mixed with a post-transition metal oxide and/or one or more salts. An efficient method of combining/mixing is achieved within an appropriate dry powder mixing unit, with careful consideration being given to the temperature and humidity conditions while the combining/mixing is taken place. In exemplary embodiments, the powders are combined and mixed under controlled conditions of temperature (preferably a constant temperature) and relative humidity. Appropriate temperatures include about 67 °F to about 70 °F, alternatively about 68 °F to about 70 °F, alternatively about 67 °F, alternatively about 68 °F, alternatively about 69 °F, alternatively about 70 °F, or any value, range, or sub-range therebetween. Exemplary relative humidities include about 15% or less, about 15% to about 10%, about 20% or less, about 5% or less, or any value, range, or sub-range therebetween.

In exemplary embodiments, the metal powder is present in an amount, by weight of the hydrogen-generating composition, about 93% or greater, alternatively about 93% to about 95%, alternatively about 94% or greater, alternatively about 95% or greater, alternatively about 96% or greater, or any value, range, or sub-range therebetween. Appropriate metals include, but are not limited to, aluminum.

In exemplary embodiments, the alkaline metal oxide powder is present in an amount, by weight of the hydrogen-generating composition, alternatively about 5% or less, alternatively about 1% to about 5%, alternatively about 6% or less, alternatively about 5% or less, alternatively about 1% to about 3%, alternatively about 4% or less, alternatively about 2% to about 4%, alternatively about 5% to about 7%, or any value, range, or sub-range therebetween. Appropriate alkaline metal oxides include, but are not limited to, calcium oxide, sodium hydroxide, or combinations thereof. In one aspect, the alkaline metal oxide powder is present in an amount, by weight of the hydrogen-generating composition, of 0.5%-2.5%. In one aspect, the alkaline metal oxide powder is present in an amount, by weight of the hydrogen-generating composition, of 1.0%-2.0%. In one aspect, the alkaline metal oxide powder is present in an amount, by weight of the hydrogen-generating composition, of 1.2%-1.8%. In one aspect, the alkaline metal oxide powder is present in an amount, by weight of the hydrogen-generating composition, of 1.4%-1.6%. In one aspect, the hydrogen generating composition is sodium hydroxide granules of a size between 50-100 microns.

In exemplary embodiments, the post-transition metal oxide powder is present in an amount, by weight of the hydrogen-generating composition, about 0.15% or less, alternatively about 0.15% or greater, alternatively about 0.1% to about 0.2%, alternatively about 0.05% to about 0.15%, alternatively about 0.15% to about 0.25%, or any value, range, or sub-range therebetween.

In exemplary embodiments, the chloride salt powder of alkali metals or alkaline earth metals is present in an amount, by weight of the hydrogen-generating composition, about 1% or less, alternatively about 0.1% to about 1%, alternatively about 0.5% to about 1%, alternatively about 0.1% to about 0.5%, alternatively about 2.5% or less, alternatively about 1.3% to about 2.5%, alternatively about 1.3% to about 1.9%, alternatively about 1.6% or less, alternatively about 1.3% to about 1.6%, alternatively about 1.6%, or any value, range, or sub-range therebetween. Appropriate chloride salt powder include, but are not limited to, NaCl, potassium chloride (KCl), and calcium chloride (CaCh).

The hydrogen-generating composition typically includes more than one chloride salt. The hydrogen-generating composition may include a sodium salt, a potassium salt, a calcium salt, and/or a chloride salt. In one embodiment, the composition includes a mixture of NaCl, KCl, and CaCh.

In exemplary embodiments, the plurality of chloride salts consists of or consists essentially of a mixture of NaCl, KCl, and CaCh.

The use of a combination of multiple metal chloride salts generates a total volume of hydrogen that is greater than when any one of the chloride salts is used alone.

In exemplary embodiments, a hydrogen-generating composition includes aluminum powder, alkaline metal oxide powder, and a mixture of powders of NaCl, KCl, and CaCh.

The powder micron size of the hydrogen-generating fuel may aid in an efficient reaction taking place. In exemplary embodiments, the raw materials (i.e. those of the powder mixture) are sieved to provide material for the fuel pouch that is of the correct particle size, preferably based on a D90 curve, where 90% of the particles have a diameter smaller than a D90 value. Appropriate D90 particle sizes include 40 μm to about 65 μm alternatively about 45 μm to about 70 μm, alternatively about 55 μm to about 65 μm, or any value, range, or sub-range therebetween.

In some embodiments, the speed of reaction is important in ensuring the accessibility of the hydrogen carrier in a multitude of situations and locations. As such, catalyst powders may be employed to change the speed of reaction, and the amount of catalyst powder that may be used within the mixture may be altered to increase or decrease the rate of reaction. Appropriate catalyst powders include, but are not limited to, sodium hydroxide. Appropriate amounts of catalyst powder include, by weight of the hydrogen-generating composition, about 2% or lower, about 1% to about 2%, about 2% to about 8%, about 2% to about 4%, about 4% to about 8%, about 8% or greater, or any value, range, or sub-range therebetween. If a higher rate of reaction is required, a larger amount of catalyst powder may be used. Additionally, if the electric generator with which the fuel is to be used is continuously used in cold climates, a larger amount of catalyst powder may be used to increase the reaction temperature and surrounding components.

Exemplary embodiments allow for low-cost production of the composition and a simple packaging method. The packaging described herein is useful to provide portability and accessibility to the end user and to provide a solution that combines safety, cost, and convenient use.

### Containment

The hydrogen-generating composition in accordance with exemplary embodiments is contained within a fuel cartridge of a packaging material that allows for physical handling of the hydrogen-generating composition, without the operator coming into direct contact with the powder. In one aspect, the powder depth (e.g., fuel pouch thickness) is not greater than 3-15 mm of the combined/mixed fuel powders. In one aspect, the powder depth is not greater than 5-13 mm of the combined/mixed fuel powders. In one aspect, the powder depth is not greater than 7-11 mm of the combined/mixed fuel powders. Width and length dimensions of the fuel cartridge may vary based on the size of the gas reaction chamber in which the fuel pouch is to be used, which may depend, for example, on the total volume of fuel needed, as it will be appreciated that the depth of the powdered fuel (e.g. wall thickness into which water flows to feed the reaction) will be the most important dimension in the complete reaction process.

In exemplary embodiments, the combined/mixed powder is packaged into a in specific measured quantity to the cartridge sectioned off into a grid where all four sides of the square/rectangle are sealed to a thin metal base that operates as a heat sink for the exothermic chemical reaction. In this fashion, the powder is secured within the cartridge, after “filling” the top of the grid has a permeable fabric sealed to hold the powdered fuel in place. In one aspect, the base of the cartridge is not metal. The top fabric can be made from a variety of materials, including but not limited to; high temperature resistant paper, Nylon, fiberglass thread, aluminum, glass, silica cloth, silicone/fiberglass cloth, copper mesh, brass mesh or Stainless-Steel Mesh. The Material must allow water to pass easily though to the powder for reaction, but securely stop any powder escaping. A preferred mesh size of 450 is required to contain the smallest combined/mixed power particle size of >500. The package cartridge material must also resist high temperatures and be inert in reactivity. These temperatures include, but are not limited to, 10 c-50 c and 20 c-60 c and 50 c to 100 c and 30 c to 120 c.

The fuel cartridge may be stored in a sealed sleeve. In exemplary embodiments, the sealed sleeve is a vacuum-sealed sleeve. In some embodiments, the sealed sleeve is made of aluminum foil. The sealed sleeve allows for long-term storage of the fuel for up to 10 years or more. When the fuel pouch is ready to be used, an end user opens the aluminum foil package and removes the fuel pouch to be placed in the reactor of an electric generator. In some embodiments, the fuel pouch is placed on a tray that is removable from the reactor and positioned within the reactor. In some embodiments, the tray is made of stainless steel. When the reaction is complete and the hydrogen released, the spent fuel pouch may be removed and returned to the sleeve for general waste disposal or preferably returned to EFG for repurposing of the powder and reuse of the cartridge.

The spent hydrogen-generating composition is preferably non-toxic and disposed by a normal garbage disposal method. It will be appreciated, however, it is possible for the spent hydrogen-generating composition to be returned to a specified location, where the powder may be removed from the fuel pouch and rejuvenated/re-conditioned to be used again within a newly-milled or newly-prepared powdered fuel mixture or the spent fuel is fully repurposed in an independent industry.

In some embodiments, pure anti-freeze (i.e., ethylene glycol) is mixed with the water used for the reaction within an electric generator. This aids in operation at temperatures below freezing in a variety of geographical locations.

Appropriate aqueous fluids supplied to the hydrogen-generating composition in a reactor may include, but are not limited to, de-ionized water, distilled water, filtered water, pond water, sea water, rainwater, human fluids, or animal fluids. These fluids may be used in conjunction with relevant filters in an electric generator, with the correct reaction program being selected.

### Example 1

A hydrogen-generating composition (referred to in this example as a fuel) according to an embodiment was tested. In one aspect, the fuel produces hydrogen gas for on demand power generation without harmful emissions. Testing was conducted to provide information about the maximum heat generation during reaction including the impact of the water addition rate, the reaction completeness, and the expansion coefficient for the reacted fuel.

Multiple fuel units were reacted with water to determine the desired reaction properties. An inverse relationship was observed between the heat of reaction and the rate of water addition to the fuel, where a reaction performed with a slower addition rate of water attained a higher maximum temperature than one performed with a faster addition rate of water. This was due to the heat capacity of water acting as a heat sink for the aluminum/hydroxide/water reaction. The highest temperature observed in the analyses was 60 °C at a water addition rate of 0.17 g/s. At optimal reaction conditions, a maximum hydrogen mass loss of 1.5 g (16.8 L) was observed.

Expansion coefficient analysis indicated the cells of the fuel cartridge should be designed to have at least 5× the volume of the solid fuel blend they contain. It is noted that, as received, there is a large disparity between the particle size of the hydrogen generating composition (estimated particle size of ~40-50 microns) and alkaline metal oxide powder (estimated particle size of ~400-500 microns) is hypothesized to lead to inconsistent blending of the fuel and suboptimal reaction contact between the two solid fuel components, leading to issues with reproducibility of the reaction data.

### Maximum Heat Production and Water Injection Rate

An inverse relationship between water injection rate and maximum temperature was observed. Because the water acts as a heat sink, the reaction never reached a temperature above 60 °C for any injection rate. No deformation or warping of the polypropylene beaker used as the reaction vessel was observed in any singular test. See TABLE 1 for the values observed. TABLE 1 illustrates the water addition rate (g/s) for 10 g of water into 10 g of fuel vs. max observed temperature (°C).

TABLE 1

| Water addition rate | Max Temperature |
|---|---|
| (g/s) | (°C) |
| 1.00 | 35 |
| 0.33 | 45 |
| 0.17 | 60 |

### Reaction Completeness

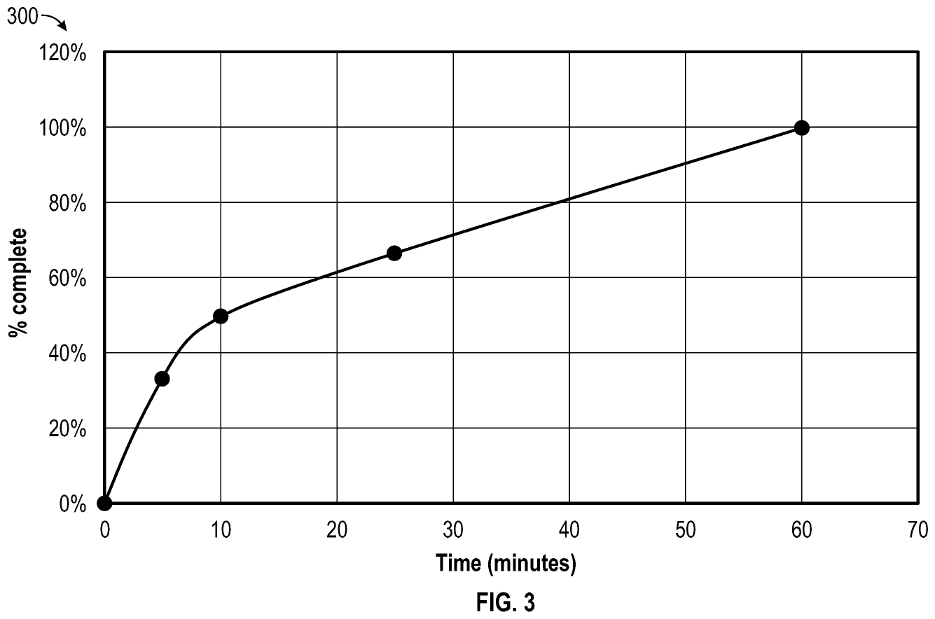

The initial reaction of the fuel occurred quickly, reaching nearly 50% completeness in the first 10 minutes, then continuing to slowly react, reaching nearly 100% completeness at 60 minutes. A representative time resolved reaction completeness graph can be found in FIG. 3 for an example of the reaction completeness of 10 g water and 10 g fuel over time. An induction period between the onset of water addition and point at which sufficient water was added to initiate the reaction was observed for each sample (i.e. it took longer for the 0.17 g/s reaction to become active than the 1.00 g/s reaction), but aside from the difference in induction period, there did not appear to be a difference in reaction rate once initiation had occurred.

Using gravimetric analysis, a maximum hydrogen mass loss of 1.5 g was observed on average across multiple runs. Stoichiometrically this translates to 16.8 liters, which is very close to an expected 17 L hydrogen production.

### Reaction Procedure

1. Charge 10 g pre-mixed fuel to a 100 mL polypropylene beaker (results in a rough depth of 7 mm).
2. Place thermocouple into center of fuel aliquot.
3. Even out layer of fuel to be flat on top.
4. Place beaker onto a pre-calibrated balance.
5. Weigh 10 mL (10 g) water in a polypropylene syringe, and add needle for injection.
6. Inject water into fuel sample at a predetermined rate using a syringe.
7. Observe and record reaction temperature and mass over time.

### Reaction Description

Initial reactions were performed on a scale of roughly 1 g fuel in an effort to understand the dynamics of the reaction with respect to vigor, gas/heat evolution, and water permeation. After a few trials with very slow hydrogen production rates the reaction method was reworked to be a 10 g fuel scale in a container that allowed for the appropriate bed depth of roughly 7 mm.

On a 10 g scale, hydrogen evolution is observed within seconds of sufficient water being added to the fuel, no mixing required. The reaction progressed vigorously within the initial 2-3 minutes of the reaction which quickly reached its maximum temperature. Once hydrogen evolution began to taper, the temperature plateaued and began to cool while hydrogen evolved at measurable levels for roughly one hour.

### Maximum Reaction Temperature and Water Injection Rate

Temperature generation reactions were performed using three aliquots from the same lot of fuel to ensure consistency of the reaction. The change in reaction temperature was measured using a thermocouple inserted into the 7 mm depth of fuel during the reaction time period. Maximum temperature of each reaction was reached within the initial 5 minutes after onset of hydrogen evolution. The procedure used was as described above with several minor modifications: (1) temperature generation reactions were performed by two analysts: (a) first analyst performed the standardized procedure and ensured the consistency in water addition rate; (b) second analyst monitored and recorded temperature as the reaction progressed; and (2) water was injected using a peristaltic pump pre-calibrated to deliver water at the desired rate.

### Reaction Completeness

The mass of the fuel/water mixture was monitored over time as a means to measure the loss of hydrogen. Regardless of the water addition rate, approximately the same reaction kinetics were observed. The mass loss was converted to a volume of hydrogen gas production using the stoichiometry of the reaction. TABLE 2 contains the mass loss data used to create the percent completeness graph seen in FIG. 3. TABLE 2 illustrates the mass loss data for a single run of 9.99 g fuel with 10 g water.

TABLE 2

| Time | Observed | Mass Lost | % |
|---|---|---|---|
| (min) | Mass (g) | (g) | Completeness |
| 0 | 9.99 | 0 | 0 |
| 5 | 9.5 | 0.49 | 33 |
| 10 | 9.25 | 0.74 | 49 |
| 25 | 9 | 0.99 | 66 |
| 60 | 8.5 | 1.49 | 99 |

### Expansion Coefficient

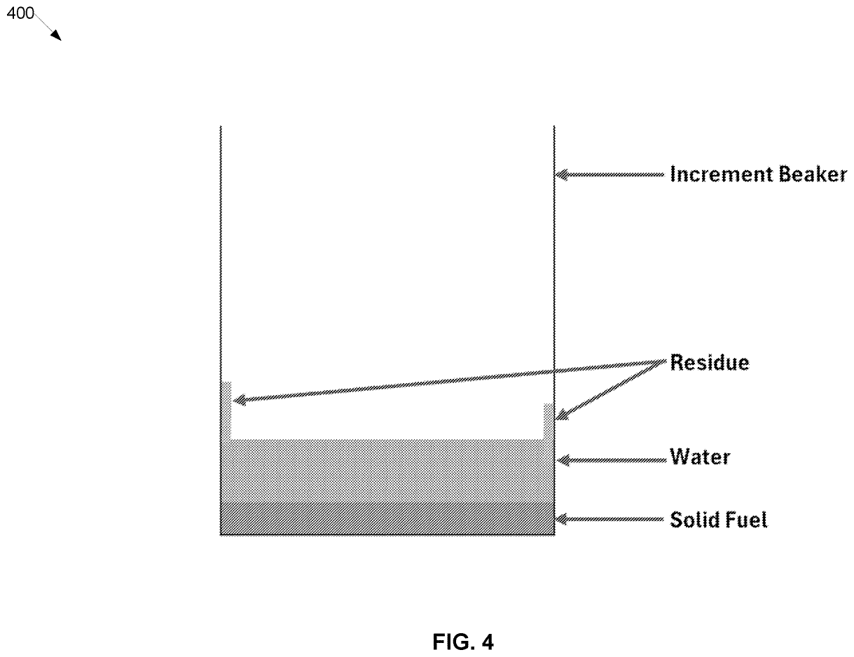

In order to measure the expansion coefficient, the volume of the solid, solid+liquid post reaction and max volume reached were recorded. This data can be found in TABLE 3, which illustrates the data used to calculate the expansion coefficient. Using this data, the expansion coefficient was calculated as 4.69 (solid basis) or (2.14 solid+liquid basis). This indicates the cells of the fuel cartridge should be designed to have at least 5× the volume of the solid fuel blend they contain. FIG. 4 shows an example of fuel and water after reaction completion. The max volume reached can be seen by the stain observed on the sides of the reaction vessel from the bubbling of the hydrogen gas as it is produced.

TABLE 3

| Material | Volume (mL) |
|---|---|
| Solid Fuel (bed depth 7 mm) | 8 |
| Solid + water (post reaction) | 17.5 |
| Max volume during reaction | 37.5 |

### Reaction Monitoring

The initial experimental design measured reaction progress through change in temperature. The reaction achieves a maximum temperature so quickly that cooling ensues while continuing to generate hydrogen. A gravimetric approach was therefore employed to measure the reaction progress.

### Water Injection Rate

If the water is injected into the center of the mass of the fuel at a decent rate no issues were observed in attaining good water permeation. The crust formation was not particularly bad.

### Fuel Component Blending

As received, the fuel contains small particle size aluminum powder (about 45 μm) and a much larger particle size of sodium hydroxide (NaOH) pellet in the blend (estimation is approximately 500 μm). It is noted that the disparity in particle size may be limiting the reaction rate when water is added. The relatively larger particle size of sodium hydroxide pellets makes ensuring the proper ratio of Al to NaOH very difficult—the NaOH pellets tend to settle out inside the packaging, making it essentially impossible to properly ascertain whether each individual 10 g aliquot contains the proper proportion of the two fuel components.

An attempt was made to further blend the sample and reduce the NaOH particle size using a mixing mill, but the fuel reacted much slower after the mixing, despite what appeared to be an improved homogenization. It was also noted that the fuel appeared more hydrophobic after shaking which may be a result of a mild oxide layer forming due to the air exposure and mild heat generated by the shaker. The sample eventually reacted but it was noticeably slower than similar reactions run with the fuel as received, though it did eventually react completely. Grinding the NaOH pellets into a finer powder and subsequently blending with the appropriate ratio of aluminum powder may mitigate this issue and may help with achieving the optimized reaction rate achievable in the conditions tested.

### Example 2

A hydrogen-generating composition (referred to in this example as a fuel) according to an embodiment was tested. In one aspect, the fuel produces hydrogen gas for on demand power generation without harmful emissions. As compared to Example 1, additional testing of the fuel kinetics was performed to better understand the impact of sodium hydroxide particle size and mass of fuel utilized on temperature generation and reaction kinetics. Unmixed samples of the aluminum and sodium hydroxide components of the fuel were received and the sodium hydroxide was ground into an equivalent particle size. The components were then blended and tested. Three additional experiments utilizing the in-house blend of fuel were conducted: (1) a 10 g fuel reaction with NaOH ground with mortar and pestle; (2) a 10 g fuel reaction with NaOH used as-received; and (3) a 20 g fuel reaction with NaOH ground with mortar and pestle.

### Effect of NaOH Homogenization on Reaction Kinetics

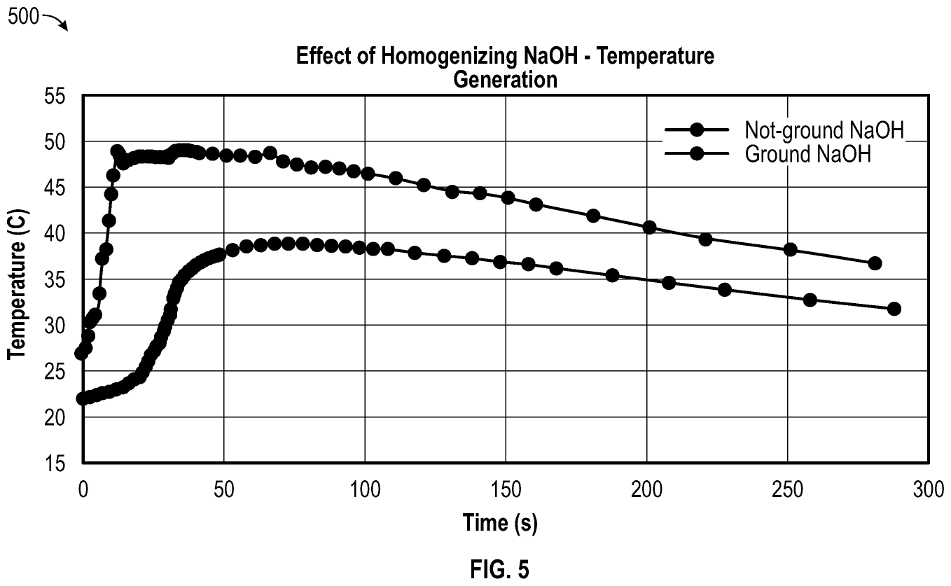

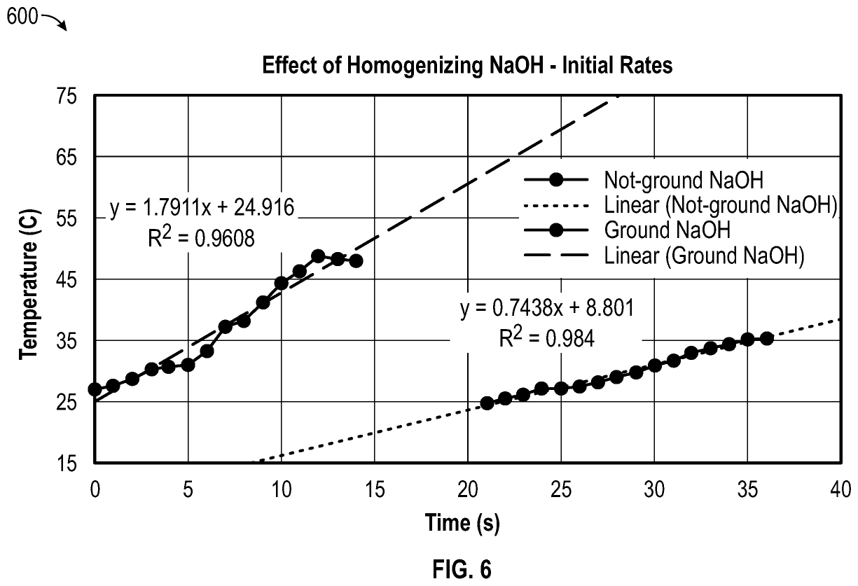

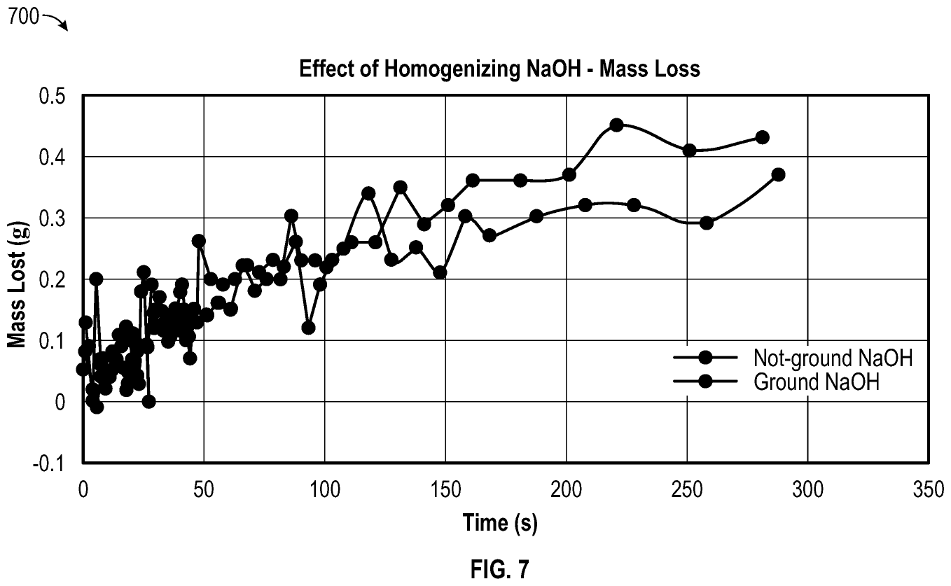

Reaction temperature and mass loss of reaction mixture were measured as a function of time and were compared directly. The grinding of NaOH pellets to a smaller particle size had a dramatic effect on the kinetics of the reaction and time to onset of the reaction once water was charged. The ground sample exhibited vigorous gas evolution almost instantly after the addition of water, whereas the non-ground sample underwent an induction period of about 20 seconds of moderate temperature increase and mild gas evolution before vigorous gas evolution was observed. This is very apparent in the direct comparison of reaction temperature in FIG. 5, which illustrates temperature as a function of time. A comparison of initial rates, depicted in FIG. 6, which illustrates a comparison of ground vs. non-ground NaOH initial rates (corrected to account for the induction period in the non-ground sample) indicates a 2.4× faster rate of temperature generation in the ground NaOH reaction. A comparison of mass lost by the two reactions as a function of time, depicted in FIG. 7, which illustrates a comparison of mass loss, shows a similar rate of loss with the ground sample potentially reaching a reactivity plateau at a lower point than the non-ground sample. Note that the mass loss data varies substantially point by point due to the balance being placed in a fume hood during the reaction for safety purposes.

### Effect of Reaction Mass/Bed Depth on Reaction Kinetics

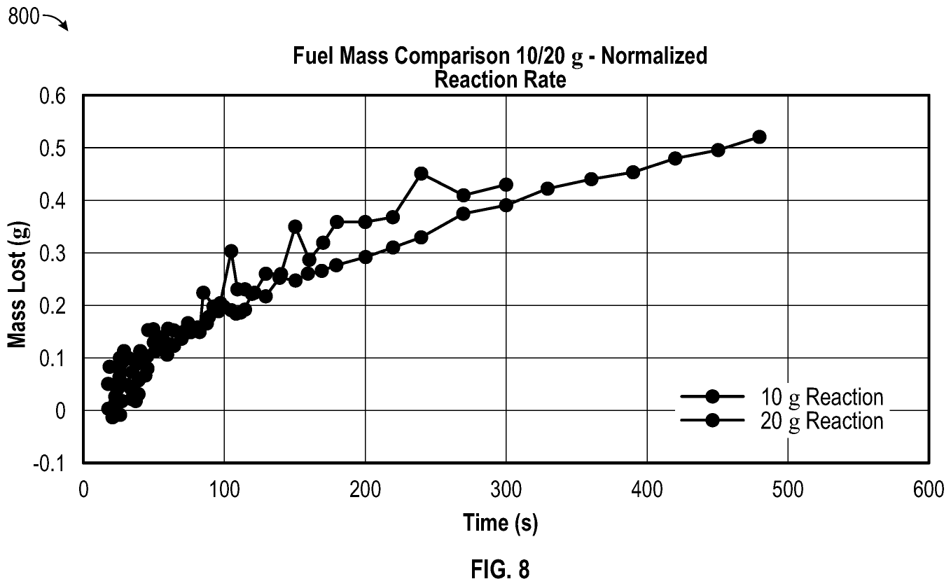

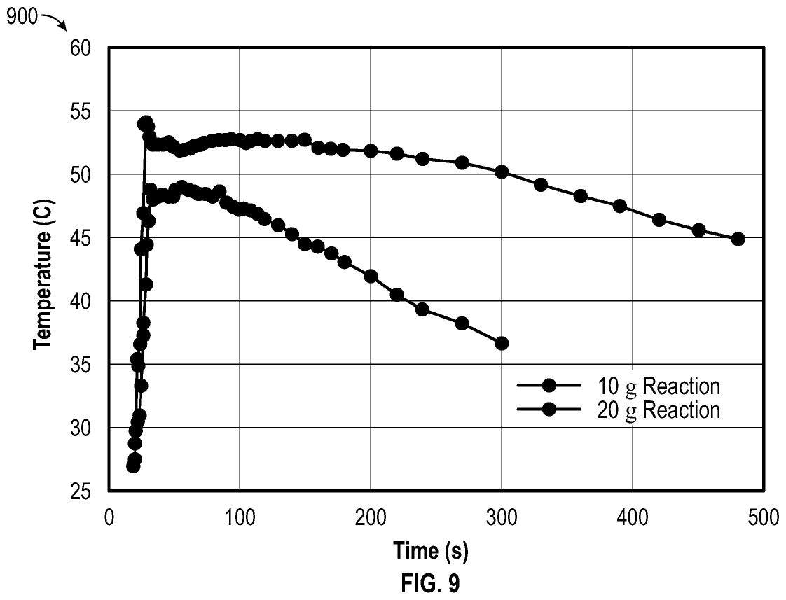

Mass loss and temperature generation were measured as a function of time in the comparison of 10 and 20 g scale reactions. Note that the 20 g scale reaction was run with a commensurate increase in water to account for the larger mass of fuel, and that both reactions were formulated with NaOH pellets that had been ground with a mortar and pestle. In both cases, once water was charged to the reaction mixture, vigorous gas evolution was observed almost instantly with no induction period observed. Reaction rate in this comparison was calculated using fuel mass lost and was normalized to account for the differences in fuel mass utilized. The normalized reaction rate comparison for the different scales of reaction, shown in FIG. 8, which illustrates a normalized reaction rate of 10 g vs. 20 g fuel mass scale, indicates there is a very similar rate of fuel consumption/hydrogen generation. This result suggests the amount of fuel and/or bed depth does not have a dramatic impact on the rate or amount of hydrogen generated by the reaction at the scale observed. Comparison of the temperature generation, pictured in FIG. 9, which illustrates a temperature generation comparison of 10 and 20 g scale reactions, a similar initial rate of temperature generation for both the 10 and 20 g scale reaction. This result suggests a similar rate of fuel/water mixing and onset of hydrogen evolution in both reaction scales. Note that upper temperature limit of fuel/water reactions appears to be limited by the water reactant acting as heat sink as well as reactant. However even considering the larger volume of water used in the 20 g fuel reaction, a higher maximum temperature was observed. This result suggests the maximum reactor cell temperature correlates with the mass of fuel in the cell, so, though similar reaction rates suggest that the amount of fuel per cell could be increased further to increase the hydrogen generated per cell, care should be taken to ensure the formulation is optimized in such a way that it will not exceed the physical limits of cartridge material construction.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified. Each reference mentioned above is incorporated by reference herein in its entirety.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A hydrogen-generating composition, wherein the hydrogen-generating composition is a powder mixture comprising a metal powder, an alkaline metal oxide powder, and at least one third powder selected from the group consisting of a post-transitional metal oxide powder, a chloride salt powder of an alkali metal, a chloride salt powder of an alkaline earth metal, and combinations thereof.

2. The hydrogen-generating composition of claim 1, wherein the metal powder is an aluminum powder.

3. The hydrogen-generating composition of claim 1, wherein the metal powder is at least 95% by weight of the hydrogen-generating composition.

4. The hydrogen-generating composition of claim 1, wherein the alkaline metal oxide powder is a calcium oxide powder.

5. The hydrogen-generating composition of claim 1, wherein the alkaline metal oxide powder is up to 7% by weight of the hydrogen-generating composition.

6. The hydrogen-generating composition of claim 1, wherein the post-transitional metal oxide powder is at least 0.15% by weight of the hydrogen-generating composition.

7. The hydrogen-generating composition of claim 1, wherein the chloride salt powder of the alkali metal or the chloride salt powder of the alkaline earth metal is up to 1% by weight of the hydrogen-generating composition.

8. The hydrogen-generating composition of claim 1, wherein the at least one third powder is selected from the group consisting of sodium chloride, potassium chloride, calcium chloride, and combinations thereof.

9. The hydrogen-generating composition of claim 1, wherein the powder mixture has a D90 particle size in the range of 30 microns to 100 microns.

10. The hydrogen-generating composition of claim 1, wherein the powder mixture further comprises a catalyst powder.

11. A fuel comprising a hydrogen-generating composition contained within a cartridge, wherein the fuel cartridge is of a grid construction with metal base, heat resistant sides and permeable top.

12. The fuel cartridge of claim 11, wherein the fuel pouch is formed of a plastic, metal and fabric.

13. The fuel cartridge of claim 11, wherein the fuel cartridge top is formed of a fabric material selected from the group consisting of Nylon, fiberglass thread, aluminum, glass, silica cloth, silicone/fiberglass cloth, copper mesh, brass mesh, or stainless-steel mesh.

14. The fuel cartridge of claim 11, wherein the fuel pouch has a mesh size of about 500 to about 140.

15. The fuel cartridge of claim 11 further comprising a sealed sleeve containing the fuel pouch.

16. The fuel cartridge of claim 15, wherein the sealed sleeve is vacuum sealed.

17. The fuel cartridge of claim 15, wherein the sealed sleeve is formed of aluminum foil.

18. A method of forming a hydrogen-generating composition comprising:
providing a metal powder, an alkaline metal oxide powder, and at least one third powder selected from the group consisting of a post-transitional metal oxide powder, a chloride salt powder of an alkali metal, and a chloride salt powder of an alkaline earth metal, the metal powder, the alkaline metal oxide powder, and the at least one third powder having a predetermined particle size; and
mixing the metal powder, the alkaline metal oxide powder, and the at least one third powder to form the hydrogen-generating composition.

19. The method of claim 18 further comprising the metal powder preferably being of a recycled nature that has undergone ball milling the metal powder to achieve the desired micron size particle, the alkaline metal oxide powder, and the least one third powder to the predetermined particle size.
